(19) United States
(12) Patent Application Publication
(10) Pub. No.: US 2018/0124762 A1
(43) Pub. Date: May 3, 2018

(54) Quantization-Based Modulation and Coding Scheme for Mobile Fronthaul

(71) Applicant: Futurewei Technologies, Inc., Plano, TX (US)

(72) Inventors: Huaiyu Zeng, Red Bank, NJ (US); Xiang Liu, Marlboro, NJ (US)

(21) Appl. No.: 15/339,562

(22) Filed: Oct. 31, 2016

(51) Int. Cl. H04W 72/04; H04L 5/00

(52) U.S. Cl. CPC H04W 72/0406; H04W 88/02; H04W 72/0446; H04L 5/0048

(57) ABSTRACT

A method implemented in a communication device, including receiving, by the communication device, quantized in-phase and quadrature (IQ) bits of an input signal, separating, by the communication device, the IQ bits into most-significant-bits (MSBs) and least-significant-bits (LSBs), encoding, by the communication device, the MSBs to generate encoded MSBs, modulating, by the communication device, the encoded MSBs with a first modulation to generate modulated encoded MSBs, modulating, by the communication device, the LSBs with a second modulation to generate modulated LSBs, combining, by the communication device, the modulated encoded MSBs and the modulated LSBs into a combined modulated signal, and transmitting, by the communication device, the combined modulated signal to a receiver through a transmission channel.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A radio access network (RAN) refers to a network between mobile devices and a core network. In customary wireless cellular networks, a region may be divided into a number of cells and cell sectors, each served by a wireless base station communicating with a core network. In the RAN, the part connecting the wireless base stations and the core network is referred to as the wireless backhaul. As the standard for high-performance wireless communications increases, wireless communication service providers are moving toward micro-cell or pico-cell deployments with denser and smaller cells.

Wireless fronthaul and mobile fronthaul are network segments that enable a centralized-RAN (C-RAN) architecture suitable for micro-cell deployments. In the RAN, digital baseband (BB) processing is normally implemented at wireless base stations located at remote cell sites. However, in a C-RAN, digital BB processing is relocated to centralized baseband units (BBUs) located at a central site near a core network. Moreover, the wireless base stations are replaced by remote radio units (RRUs) which interface with antennas for wireless radio frequency (RF) transmission and reception. The RRUs require limited digital BB processing.

In C-RAN, a fronthaul is located between the BBUs and the RRUs. The fronthaul digitizes wireless channels, aggregates the digitized channels, and transports the aggregated channels using an aggregated fiber optical channel or aggregated microwave channel. C-RAN is conventionally supported by the common public radio interface (CPRI) based on binary modulation, which is not efficient in terms of both bandwidth and power. Since the aggregated channel requires complex communications configurations for high data rate performance and lack of efficiency from CPRI binary modulation, an efficient mobile fronthaul (EMF) is needed for increased bandwidth efficiency, power efficiency, and ultimately, cost efficiency.

### SUMMARY

In an embodiment, the disclosure includes a method implemented in a communication device, including receiving, by the communication device, quantized in-phase and quadrature (IQ) bits of an input signal, separating, by the communication device, the IQ bits into most-significant-bits (MSBs) and least-significant-bits (LSBs), encoding, by the communication device, the MSBs to generate encoded MSBs, modulating, by the communication device, the encoded MSBs with a first modulation to generate modulated encoded MSBs, modulating, by the communication device, the LSBs with a second modulation to generate modulated LSBs, combining, by the communication device, the modulated encoded MSBs and the modulated LSBs into a combined modulated signal, and transmitting, by the communication device, the combined modulated signal to a receiver through a transmission channel.

In an embodiment, the MSBs are encoded using forward error correction (FEC). In an embodiment, the MSBs are encoded using a Trellis coded modulation. In an embodiment, the first modulation is a quadrature amplitude modulation (QAM). In an embodiment, the second modulation is a pulse-code modulation (PCM). In an embodiment, the combined modulated signal is transmitted using a frequency-domain discrete multi-tone (FD-DMT) transmitter. In an embodiment, the combined modulated signal is transmitted using a time-domain single-carrier (TD-SC) transmitter.

In an embodiment, the disclosure includes a receiver configured to receive a combined modulated signal including MSBs and LSBs of an input signal, a processor coupled to the receiver and configured to separate the MSBs from the combined modulated signal via a first demodulation and decoding, separate the LSBs from the combined modulated signal via a second demodulation, wherein the second demodulation is different from the first demodulation, recombine the MSBs and the LSBs to generate a reconstructed representation of the input signal including in-phase and quadrature (IQ) bits, and provide the IQ bits to a remote radio unit (RRU) for transmission to a mobile device via an antenna.

In an embodiment, the demodulation is a quadrature amplitude modulation (QAM). In an embodiment, the MSBs are decoded by a forward error correction (FEC) decoder. In an embodiment, the second demodulation is a pulse-code modulation (PCM). In an embodiment, the receiver is a frequency-domain discrete multi-tone (FD-DMT) transmitter. In an embodiment, the receiver is a time-domain single-carrier (TD-SC) transmitter. In an embodiment, a channel equalizer is coupled to the receiver and configured to equalize the combined modulated signal including the MSBs and the LSBs. In an embodiment, the channel equalizer is updated using the MSBs. In an embodiment, the channel equalizer is trained using training symbols.

In an embodiment, the disclosure includes a receiver configured to receive an input signal including in-phase and quadrature (IQ) bits and control words (CWs) bits, a processor coupled to the receiver and configured to divide the IQ bits into most-significant-bits (MSBs) and least-significant-bits (LSBs), encode the MSBs to form encoded MSBs, modulate the encoded MSBs with a first modulation to form a modulated encoded MSBs, modulate the LSBs with a second modulation to form a modulated LSBs, combine the modulated encoded MSBs and the modulated LSBs into a combined modulated signal, and a transmitter coupled to the processor and configured to synchronously transmit the combined modulated signal to a receiver over a transmission channel.

In an embodiment, the MSBs and LSBs are divided according to an error-vector-magnitude (EVM) requirement. In an embodiment, the MSBs are modulated with a quadrature amplitude modulation (QAM) following the encoding. In an embodiment, the processor is further configured to adjust a mean power of the modulated LSBs with respect to a mean power of the modulated encoded MSBs. In an embodiment, a difference between a mean power of the modulated LSBs and a mean power of the modulated encoded MSBs is determined according to an error-vector-magnitude (EVM) requirement. In an embodiment, the processor is further configured to generate normalization bits before the IQ bits are divided. In an embodiment, the normalization bits are transmitted together with the MSBs of the combined modulated signal. In an embodiment, the control words (CWs) bits are transmitted together with the MSBs of the combined modulated signal.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a C-RAN system.

FIG. 2 is a schematic diagram of a conventional CPRI compression-based mobile fronthaul communication system.

FIG. 3 is a graph illustrating typical optical channel signal-to-noise ratio (SNR) versus subcarrier without pre-compensation.

FIG. 4 is a graph illustrating simulation channel SNR versus subcarrier with pre-compensation.

FIG. 5 is a graph illustrating simulation bit-error ratio (BER) versus subcarrier with pre-compensation.

FIG. 6 is a graph illustrating received QAM constellation points with pre-compensation.

FIG. 7A is a schematic diagram of a quantization-based MCS fronthaul communication system that comprises a transmitter and a receiver configured to send and receive packets over a transmission channel according to an embodiment of the disclosure.

FIG. 7B is a schematic diagram of a quantization-based MCS fronthaul communication system that comprises a sub-transmitter and a sub-receiver configured for dynamic equalizer training according to an embodiment of the disclosure.

FIG. 8 is a schematic diagram of a quantization-based MCS fronthaul processing device according to an embodiment of the disclosure.

FIG. 9 is a graph illustrating BER versus subcarrier with quantization-based MCS according to an embodiment of the disclosure.

FIG. 10 is a graph illustrating received QAM constellation points with quantization-based MCS according to an embodiment of the disclosure.

FIG. 11 is a graph illustrating received Long Term Evolution (LTE) QAM constellation points with quantization-based MCS according to an embodiment of the disclosure.

FIG. 12 is a flowchart of a method of performing quantization-based MCS processing by a transmitter and a receiver configured to send and receive packets over a transmission channel according to an embodiment of the disclosure.

### DETAILED DESCRIPTION

It should be understood at the outset that, although illustrative implementations of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

According to various embodiments of the present disclosure, quantization-based modulation and coding scheme (MCS) is provided. Transmitters in fronthauls, which are located in BBUs, RRUs, or other suitable components, compress in-phase and quadrature (IQ) data by adding one or more bits and separate the IQ data into a string of most-significant-bits (MSBs) and a string of least-significant-bits (LSBs). The transmitters then protect the MSBs by performing a forward error correction (FEC) encoding or a Trellis coded modulation (TCM). Thereafter, the transmitters modulate the MSBs with a digital modulation such as quadrature amplitude modulation (QAM) and the transmitters further modulate the LSBs with a pulse-code modulation (PCM). Next, the transmitters transmit the protected MSBs and unprotected LSBs synchronously to a remote unit such as RRUs, BBUs, or other suitable remote cell structure. In comparison to conventional EMFs, the quantization-based MCS fronthauls provide higher transmission performance and reduction in EVM due to the protection of the MSBs. Furthermore, the quantization-based MCS fronthauls offer higher bandwidth efficiency due to the utilization of PCM and further reduce a digital signal processing complexity of the C-RAN system by removing the protection on LSBs as opposed to the conventional scheme.

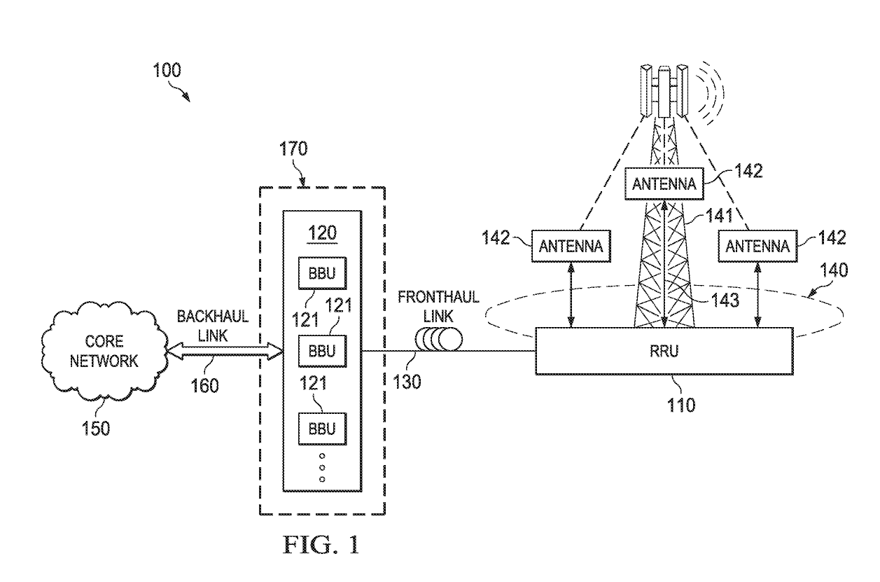

FIG. 1 is a schematic diagram of a C-RAN system 100. The C-RAN 100 generally comprises a core network 150 communicatively coupled to a central office (CO) 170 through a backhaul link 160 and a remote cell site 140 communicatively coupled to the CO 170 through a fronthaul link 130. The CO 170 comprises a BBU pool 120. The remote cell site 140 comprises a RRU 110, a plurality of antennas 142, and a cell tower 141. The components of the C-RAN 100 may be arranged as shown or in any other suitable manner.

The core network 150 may comprise interconnected sub-networks operated by service providers. The core network 150 is a central part of a larger network that provides network services to mobile devices in the sub-networks. The backhaul link 160 may be a cable link, a free-space microwave link, a digital subscriber line (DSL) link, an optical fiber link, or any suitable combinations of components configured to transport packets such as Ethernet packets between the core network 150 and the BBU pool 120. The BBU pool 120 is normally located at the CO 170 and comprises a plurality of BBUs 121. The CO 170 may be a building, a part of a building, other structure or facility that houses the BBU pool 120. The BBUs 121 are devices configured to perform BB digital signal processing (DSP) functions and wireless media access control (MAC) processing functions according to a wireless communication protocol.

The fronthaul link 130 may be a cable link, a free-space microwave link, or an optical fiber link configured to communicate digital baseband signals between the BBU pool 120 and the RRU 110. The RRU 110 is typically located in a remote cell site 140 at the bottom of the cell tower 141. The remote cell site 140 is a geographical area located at a remote location away from the CO 170 and may comprise one or more cell sectors, which may be determined during network deployment.

The RRU 110 is communicatively coupled to the antennas 142 through a link 143, which may be any suitable link for transporting RF signals. The RRU 110 is configured to communicate with the mobile devices by using designated wireless uplink (UL) RF channels and designated wireless downlink (DL) RF channels through the antennas 142. DL refers to the transmission direction from the CO 170 towards the mobile devices through the remote cell site 140, whereas UL refers to the transmission direction from the mobile devices towards the CO 170 through the remote cell site 140. The wireless DL and wireless UL RF channels may be Long-Term Evolution (LTE), LTE Advanced (LTE-A), or other evolved Universal Mobile Telecommunications System Terrestrial Radio Access (e-UTRA) channels. The wireless RF channels may carry signals that are modulated by various modulation schemes, such as orthogonal frequency-division multiplexing (OFDM), filtered OFDM, multi-band OFDM, discrete Fourier transform (DFT)-spread OFDM, filter bank multicarrier (FBMC), and/or universal filtered multicarrier (UFMC).

In a DL direction, the core network 150 forwards DL data packets to the BBU pool 120 through the backhaul link 160. The BBUs 121 generate DL signals for the mobile devices from corresponding DL data packets by performing BB processing and MAC processing. The BBUs 121 aggregate the DL signals into aggregated DL signals and transmit the aggregated DL signals to the RRU 110 through the fronthaul link 130. The RRU 110 deaggregates the aggregated DL signals and transmits the deaggregated DL signals to the mobile devices in corresponding DL RF channels.

In a UL direction, the RRU 110 receives UL RF signals from the mobile devices, converts them to UL BB signals, and aggregates the UL BB signals into aggregated UL signals. The RRU 110 then sends the aggregated UL signals to the BBU pool 120 through the fronthaul link 130. The BBUs 121 deaggregate the aggregated UL signals and perform BB processing and MAC processing on the deaggregated UL signals to recover the original UL RF signals from the mobile devices. The BBUs 121 convert the UL RF signals into packets and transmit the packets to the core network 150 through the backhaul link 160. The BBUs 121 may coordinate with each other to jointly process one or more aggregated UL signals from one or more RRUs 110.

The BBU pool 120, the fronthaul link 130, and the RRU 110 compose a fronthaul or an EMF. An EMF system employing cascaded waveform modulation control word (CWM-CW) to improve EMF transmission performance without increasing system complexity and hardware cost is described in U.S. patent application Ser. No. 15/179,526 filed on Jun. 10, 2016, by Xiang Liu, et al, and titled “Cascaded Waveform Modulation with an Embedded Control Signal for High-Performance Mobile Fronthaul,” which is incorporated by reference. The fronthaul communicates digital representations of analog wireless signals, normally in the form of digitized in-phase (I) components and quadrature (Q) components of BB signals, which are referred to as IQ data. The fronthaul further communicates control words (CWs), which are used by BBUs 121 and the RRU 110 for equipment control and management. The fronthaul communicates the IQ data on an IQ channel and communicates the CWs on a CW channel.

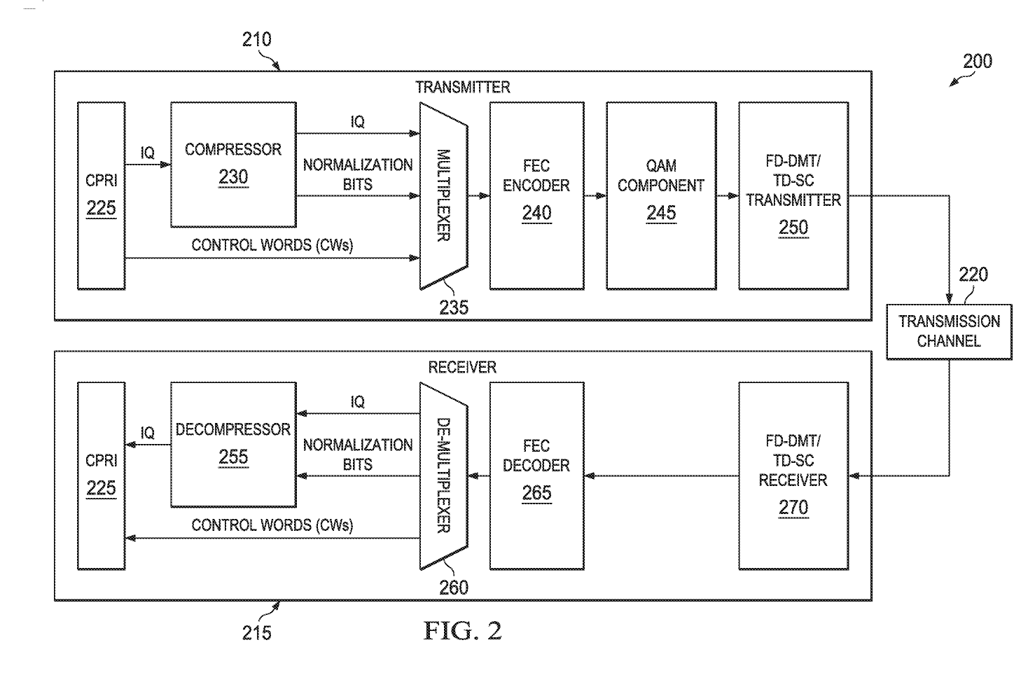

FIG. 2 is a schematic diagram of a conventional CPRI compression-based mobile fronthaul communication system 200. The system 200 includes a transmitter 210 and a receiver 215 configured to send and receive packets over a transmission channel 220. The transmission channel 220 is similar to the fronthaul link 130 in FIG. 1. In the DL direction, the transmitter 210 is located at the BBU 120 and the receiver 215 is located at the RRU 110. In the UL direction, the transmitter 210 is located at the RRU 110 and the receiver 215 is located at the BBU 120. The transmitter 210 serves as an optical frontend to modulate and transmit data onto a single optical carrier signal over the transmission channel 220. The receiver 215 processes the single optical carrier signal received over the transmission channel 220 into IQ data and CW for RRU 110 processing and further transmission to the mobile devices.

The transmitter 210 comprises a CPRI 225, a compressor 230, a multiplexer 235, a FEC encoder 240, a QAM component 245, and a sub-transmitter 250. In the DL direction, the CPRI 225 transmits IQ data to the compressor 230 and transmits CWs to the multiplexer 235. The compressor 230 performs a compression to the IQ data to generate compressed IQ data. The compressor 230 transmits the compressed IQ data and normalization bits to the multiplexer 235. The multiplexer 235 formulates the compressed IQ data, the normalization bits, and CWs into a combined IQ-CW signal and transmits the combined IQ-CW signal to the FEC encoder 240. In an embodiment, the combined IQ-CW signal comprises CPRI protocol signals. The FEC encoder 240 performs an encoding on the combined IQ-CW signal to generate an encoded IQ-CW signal and transmits the encoded IQ-CW signal to the QAM component 245. The QAM component 245 modulates the encoded IQ-CW signal to generate a modulated IQ-CW signal and transmits the modulated IQ-CW signal to a sub-transmitter 250. In an embodiment, the sub-transmitter 250 is a frequency-domain discrete multitoned (FD-DMT) sub-transmitter or a time-domain single-carrier (TD-SC) sub-transmitter. The sub-transmitter 250 transmits the modulated IQ-CW signal over the transmission channel 220.

The receiver 215 receives the modulated IQ-CW signal from the transmitter 210 through transmission channel 220. The receiver 215 comprises a CPRI 225, a decompressor 255, a de-multiplexer 260, a FEC decoder 265, and a sub-receiver 270. In an embodiment, the sub-receiver 270 is a TD-SC sub-receiver or a FD-DMT sub-receiver. The sub-receiver 270 receives the modulated IQ-CW signal from the transmission channel 220 and transmits the modulated IQ-CW signal to the FEC decoder 265. The FEC decoder 265 performs a decoding on the modulated IQ-CW signal to generate a combined IQ-CW signal and transmits the combined IQ-CW signal to the de-multiplexer 260. The de-multiplexer 260 performs a de-multiplexing on the combined IQ-CW signal to form compressed IQ data, normalization bits, and CWs. The de-multiplexer 260 transmits the compressed IQ data and the normalization bits to decompressor 255 and transmits the CWs to CPRI 225. The decompressor 255 performs a decompression on the compressed IQ data and the normalization bits to obtain IQ data and transmits the IQ data to CPRI 225. The CPRI 225 receives or generates IQ data and provides the IQ data to the RRU 110 and eventually transmits the IQ data to the mobile devices via antennas 142. Although the DL and UL data transmissions of transmitter 210 and receiver 215 are sufficient to perform the mobile fronthaul scheme of the C-RAN system 100, such conventional fronthaul CPRI compression scheme has drawbacks such as, for example, an increased amount of signal redundancy and degradation in EVM.

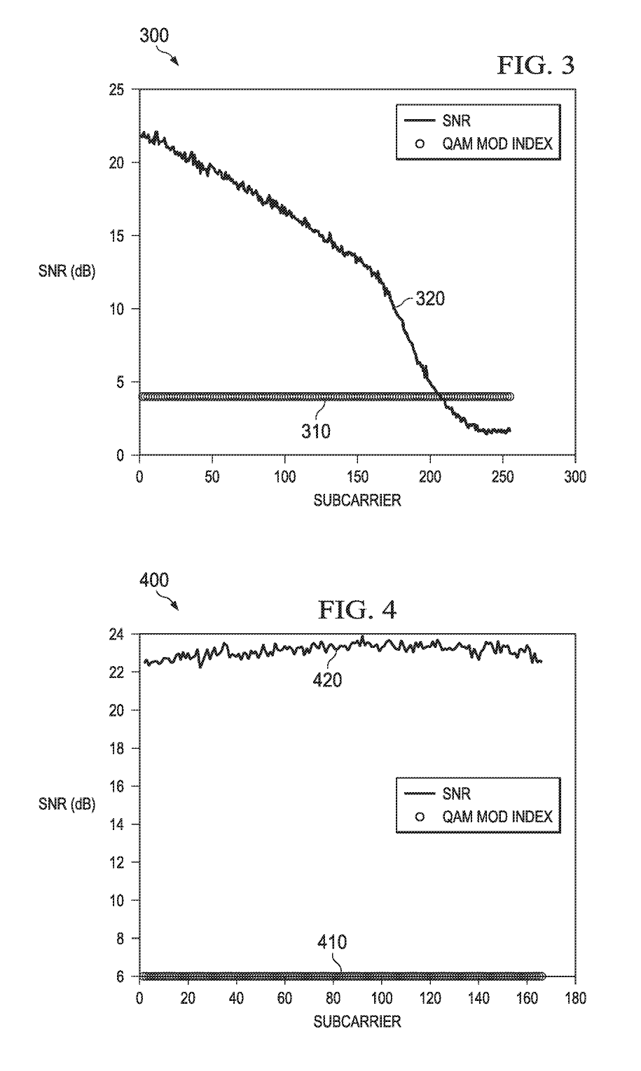

FIG. 3 is a graph 300 illustrating typical optical channel SNR versus subcarrier without pre-compensation. The x-axis represents subcarrier in constant units, and the y-axis represents SNR in decibels (dB). The graph 300 comprises two lines, a first line 310 representing QAM index and a second line 320 representing signal-to-noise ratio (SNR). As shown, in a typical optical transmission channel without pre-compensation, the SNR falls off sharply at about subcarrier unit value 170. Graph 300 illustrates an undesirable response from the conventional fronthaul system. For example, a desirable efficient fronthaul would prevent the fall off of SNR and maintain the SNR at a desirable range.

FIG. 4 is a graph 400 illustrating simulation channel SNR versus subcarrier with pre-compensation. The x-axis represents subcarrier in constant units, and the y-axis represents SNR in decibels (dB). The graph 400 comprises two lines, a first line 410 representing quadrature amplitude modulation (QAM) index and a second line 420 representing SNR. As shown, the SNR is maintained at about 23 dB. In order to achieve optimal transmission of clean signals, a flattened SNR line with high decibel value is preferred.

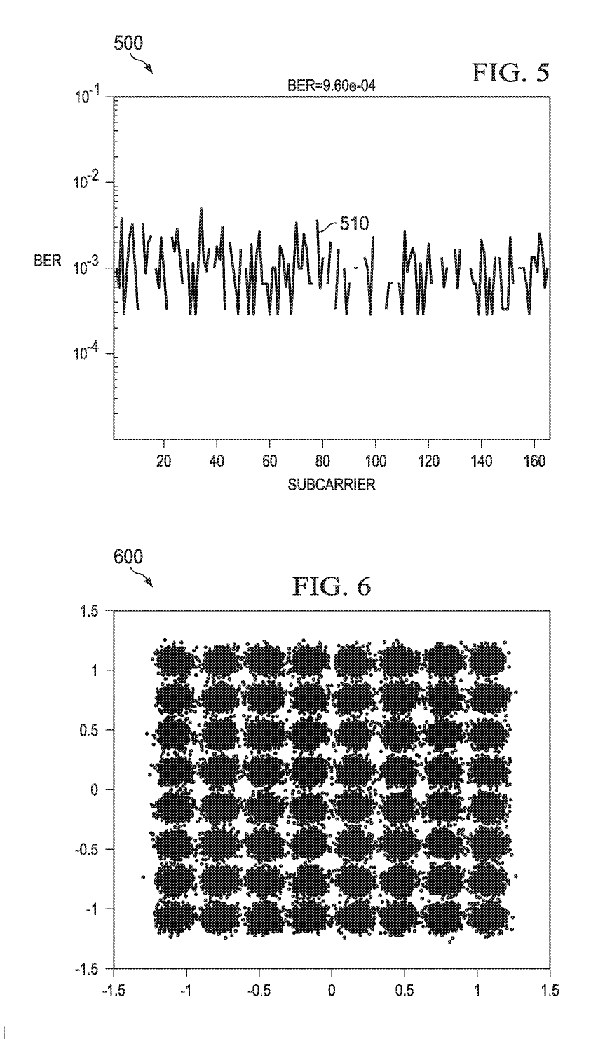

FIG. 5 is a graph 500 illustrating simulation BER versus subcarrier with pre-compensation. The x-axis represents subcarrier in constant units, and the y-axis represents BER in constant units. The graph 500 comprises a first line 510 representing BER sampled per subcarrier unit. As shown, the BER is within a range between about 10⁻² and about 10⁻⁴ centered at about 10⁻³. The graph further displays a value BER=9.60e⁻⁰⁴ representing a ratio comprises a number of bit-errors divided by a total number of transferred bits during a transmission period.

FIG. 6 is a graph 600 illustrating received QAM constellation points with pre-compensation. The x-axis represents in-phase (I) in constant units, and the y-axis represents quadrature (Q) in constant units. The graph 600 is a constellation diagram that comprises a plurality of sampling dots. The sampling dots represent the IQ data taken from the input of FEC decoder 265 in the receiver 215. In an ideal fronthaul transmission, the IQ data sampling is more concentrated.

Disclosed herein are various embodiments for improving EMF transmission performance by employing quantization-based MCS for mobile fronthaul or EMFs. For example, quantization-based MCS represents a separating process of the IQ data into MSBs and LSBs. The quantization-based MCS mobile fronthaul protects the MSBs with an encoding to form encoded MSBs and then modulates the encoded MSBs with a QAM to form modulated encoded MSBs. Next, the quantization-based MCS mobile fronthaul modulates the LSBs with a PCM to form modulated LSBs. The quantization-based MCS fronthaul transmits the modulated encoded MSBs and the modulated LSBs synchronously to a remote receiver through a transmission channel. In another example, a receiver receives the synchronized stream of modulated encoded MSBs and modulated LSBs and then performs de-multiplexing on the synchronized stream of the modulated encoded MSBs and the modulated LSBs to generate de-multiplexed modulated encode MSBs and de-multiplexed modulated LSBs. In other words, the modulated encoded MSBs in the synchronized stream are separated from the modulated LSBs. The de-multiplexed modulated encoded MSBs are decoded to form de-multiplexed modulated MSBs and transmitted to a de-multiplexer. The de-multiplexed modulated MSBs are further de-multiplexed into normalized bits, CWs, and modulated MSBs. The modulated MSBs then are demodulated back to the MSBs using a PCM, as the modulated LSBs are in PCM format. Since both the MSBs and the modulated LSBs are now in PCM format, the MSBs and the modulated LSBs are combined into IQ data. Thereafter, the decompressor forms an estimated IQ data for further transmission purposes. As a result, the quantization-based MCS fronthaul offers higher bandwidth efficiency and lower system complexity due to the PCM and by removing the need to encode an entire IQ data. Moreover, by protecting the MSBs of the IQ data, the transmission performance is increased. The disclosed embodiments improve system performance without significantly increasing system complexity and hardware cost.

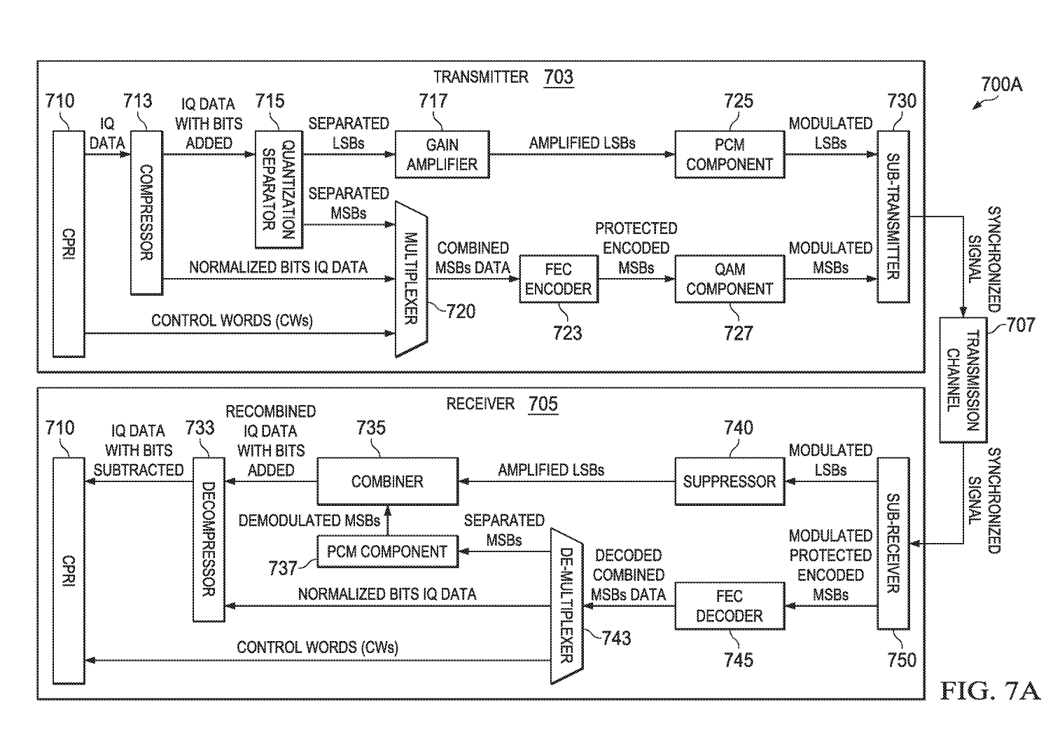

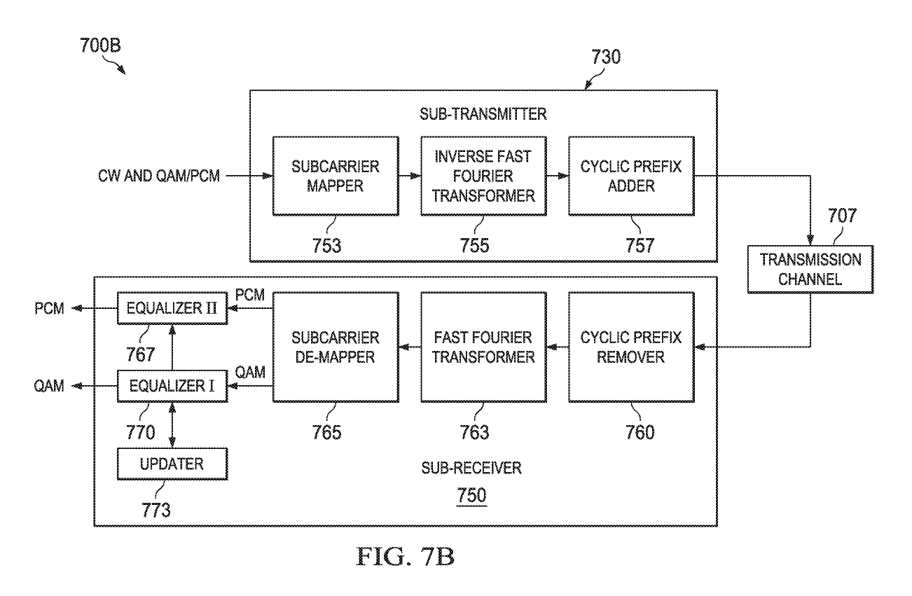

FIG. 7A is a schematic diagram of a quantization-based MCS fronthaul communication system 700A that comprises a transmitter 703 and a receiver 705 configured to send and receive packets over a transmission channel 707 according to an embodiment of the disclosure. The transmitter 703 and the receiver 705 are similar to the transmitter 210 and the receiver 215 of FIG. 2. The transmission channel 707 is similar to the fronthaul link 130 in FIG. 1 and the transmission channel 220 in FIG. 2. In the DL direction, the transmitter 703 is located at the BBU 120 and the receiver 705 is located at the RRU 110. In the UL direction, the transmitter 703 is located at the RRU 110 and the receiver 705 is located at the BBU 120. The transmitter 703 serves as an optical frontend to modulate and transmit data onto a single optical carrier signal over the transmission channel 707. The receiver 705 processes the single optical carrier signal received over the transmission channel 707 into IQ data and CW for RRU 110 processing and further transmission to the mobile devices.

The transmitter 703 comprises a CPRI 710, a compressor 713, a quantization separator 715, a gain amplifier 717, a multiplexer 720, a FEC encoder 723, a PCM component 725, a QAM component 727, and a sub-transmitter 730. In an embodiment, the sub-transmitter 730 may be a FD-DMT sub-transmitter or a TD-SC sub-receiver. In a DL direction embodiment, the CPRI 710 receives or generates IQ data and transmits the IQ data to the compressor 713 for compression of IQ data and transmits CWs to the multiplexer 720. Thereafter, the compressor 713 performs a compression. The compression performed by the compressor 713 is similar to the compression performed by the compressor 230 except that one or more bits are added to the compressor IQ output. The compressor output IQ bits are sent to the quantization separator 715. The compressor 713 also transmits normalized bits to the multiplexer 720. Next, the quantization separator 715 separates the compressed IQ data into most-significant-bits (MSBs) and least-significant-bits (LSBs), and transmits the MSBs to the multiplexer 720 and the LSBs to the gain amplifier 717.

The gain amplifier 717 amplifies the LSBs to generate amplified LSBs and transmits the amplified LSBs to the PCM component 725. The multiplexer 720 performs multiplexing on the MSBs, the normalized bits, and the CWs to form combined MSBs and transmits the combined MSBs to the FEC encoder 723. The FEC encoder 723 performs an encoding on the MSBs to generate encoded MSBs and transmits the encoded MSBs to the QAM component 727. The PCM component 725 modulates the amplified LSBs to generate a PCM LSBs and transmits the PCM LSBs to the sub-transmitter 730. The QAM component 727 modulates the encoded MSBs to generate QAM MSBs and transmits the QAM MSBs to the sub-transmitter 730. The sub-transmitter 730 transmits the PCM LSBs and the QAM MSBs synchronously in a single optical carrier signal to a remote receiver 705 over the transmission channel 707.

The single optical carrier signal is received by the receiver 705. The receiver 705 comprises a CPRI 710, a decompressor 733, a combiner 735, a PCM component 737, a suppressor 740, a de-multiplexer 743, a FEC decoder 745, and a sub-receiver 750. In an embodiment, the sub-receiver 750 may be a FD-DMT sub-receiver or a TD-SC sub-receiver. The sub-receiver 750 receives the single optical carrier signal from the transmission channel 707 and transmits the QAM MSBs to the FEC decoder 745 and the PCM LSBs to the suppressor 740. The FEC decoder 745 decodes the QAM MSBs to generate a combined QAM MSBs and transmits the combined QAM MSBs to the de-multiplexer 743.

The de-multiplexer 743 performs a de-multiplexing to separate the combined QAM MSBs into the CWs, the normalized bits, and a compressed QAM MSBs. The de-multiplexer 743 transmits the CWs directly to the CPRI 710, the normalized bits to decompressor 733, and the compressed QAM MSBs to the PCM component 737. Thereafter, the suppressor 740 performs suppression on the PCM LSBs to generate a suppressed PCM LSBs and transmits the suppressed PCM LSBs to the combiner 735. The suppression represents a reverse process as opposed to the amplifying process performed on the LSBs in above mentioned transmitter scheme. The PCM component 737 forms the MSBs of IQ data using the compressed QAM MSBs and sends the MSBs of IQ data to the combiner 735. The combiner 735 combines the suppressed PCM LSBs and the MSBs of IQ data to generate a compressed IQ data and transmits the compressed IQ data to the decompressor 733. The decompressor 733 decompresses the compressed IQ data to generate IQ data and transmits the IQ data to the CPRI 710. The CPRI 710 provides the IQ data to the RRU 110 and eventually transmits the IQ data to the mobile devices via antennas 142. The above mentioned flow scheme completes the DL of data transmission from BBU 120 to RRU 110, whereas the UL of data transmission would be an opposite flow scheme from RRU 110 to BBU 120 as opposed to the above mentioned scheme.

To demonstrate the difference in spectrum efficiency gain between the conventional CPRI compression fronthaul such as the transmitter 210 and the receiver 215 and the disclosed embodiments of quantization-based MCS fronthaul such as transmitter 703 and receiver 705 configured to send and receive over a transmission channel 707, a spectrum efficiency gain formula is used. For example, the spectrum efficiency gain formula comprises a CPRI compression spectrum efficiency formula and a quantization-based MCS spectrum efficiency formula. The spectrum efficiency formula for the CPRI compression fronthaul is as follows:

$${N}_{CPRI} = \frac{{N}_{tot}}{( {N}_{IQ} + {N}_{norm} + {N}_{cw} ) ( 1 + {OH}_{FEC} )} \qquad ( 1 )$$

where Nₜₒₜ is a number of total transmitted bits per OFDM frame, N_{IQ} is a number of quantization bits per IQ sample, Nₙₒᵣₘ is a number of normalization bits per IQ sample, N_{cw} is a number of control words per IQ sample, and OH_{FEC} is a FEC overhead value. By way of example, the overhead values may be about 7% for a BER threshold of 1e-3, about 12% for a BER threshold of 3e-3, and so on as would be recognized by one skilled in the art. The spectrum efficiency formula for the quantization-based MCS fronthaul is as follows:

$${N}_{EMF} = \frac{{N}_{tot}}{{N}_{a} + ( K + {N}_{norm} + {N}_{cw} ) ( 1 + {OH}_{FEC} )} \qquad ( 2 )$$

where Nₜₒₜ is a number of total transmitted bits per OFDM frame, Nₐ is a number of the unprotected least-significant-bits, K is a number of the protected most-significant-bits, Nₙₒᵣₘ is a number of normalization bits per IQ sample, N_{cw} is a number of control words per IQ sample, and OH_{FEC} is a FEC overhead value.

In one embodiment, OFDM subcarriers may be used with SNR of 23 dB to carry 6 bits (k & Nₐ=6) on each subcarrier by using a 64-QAM for the quantization-based MCS fronthaul optical channel to achieve error-free performance after FEC protection, where the BER is less than 1e-12 after the FEC decoding. The subcarriers may also support PCM with an effective number of bits (ENOB) of 3.833 per quadrature, leading to an overall ENOB of 6.883 per quadrature where a digital modulation is combined with the PCM modulation at the receiver. The overall ENOB corresponds to an EVM of about 0.88%, which is less than conventional fronthaul EVM value of 1%.

Consequently, the spectrum efficiency gain formula is as follows:

$$\frac{{N}_{EMF}}{{N}_{CPRI}} = \frac{( {N}_{IQ} + {N}_{norm} + {N}_{cw} ) ( 1 + {OH}_{FEC} )}{{N}_{a} ( K + {N}_{norm} + {N}_{cw} ) ( 1 + {OH}_{FEC} )} \qquad ( 3 )$$

where Nₜₒₜ is a number of total transmitted bits per OFDM frame, Nₐ is a number of the unprotected least-significant-bits, N_{IQ} is a number of quantization bits per IQ sample, K is a number of the protected most-significant-bits, Nₙₒᵣₘ is a number of normalization bits per IQ sample, N_{cw} is a number of control words per IQ sample, and OH_{FEC} is a FEC overhead value. For the disclosed embodiments of quantization-based MCS fronthaul, after calculations of the spectrum efficiency gain formula are applied to the typical system simulations with FEC overhead values such as 7%, 12%, and 20%, a set of spectrum efficiency gain results is calculated as follows: about 14% spectrum efficiency gain for 7% overhead FEC, about 16% spectrum efficiency gain for 12% overhead FEC, and about 19% spectrum efficiency for 20% overhead FEC.

Aside from spectrum efficiency gain, the quantization-based MCS fronthaul also improves FEC complexity. The FEC complexity improvement may be demonstrated by a FEC complexity formula made up by a CPRI compression FEC formula and a quantization-based MCS FEC formula. The CPRI compression where all the IQ data are protected by using FEC is as follows:

N_{FEC}_{_}_{CPRI}=(N_{IQ}+Nₙₒᵣₘ+N_{cw})(1+OH_{FEC}) (4)

where N_{IQ} is a number of quantization bits per IQ sample, Nₙₒᵣₘ is a number of normalization bits per IQ sample, N_{cw} is a number of control words per IQ sample, and OH_{FEC} is a FEC overhead value. The quantization-based MCS formula where the normalization, the CWs, and the MSBs are protected using FEC is as follows:

N_{FEC}_{_}_{EMF}=(K+Nₙₒᵣₘ+N_{cw})(1+OH_{FEC}) (5)

where K is a number of the protected most-significant-bits, Nₙₒᵣₘ is a number of normalization bits per IQ sample, N_{cw} is a number of control words per IQ sample, and OH_{FEC} is a FEC overhead value.

Consequently, the FEC complexity formula is as follows:

$$\frac{{N}_{FEC \_ EMF}}{{N}_{FEC \_ CPRI}} = \frac{( K + {N}_{norm} + {N}_{cw} ) ( 1 + {OH}_{FEC} )}{( {N}_{IQ} + {N}_{norm} + {N}_{cw} ) ( 1 + {OH}_{FEC} )} \qquad ( 6 )$$

where K is a number of the protected most-significant-bits, N_{IQ} is a number of quantization bits per IQ sample, Nₙₒᵣₘ is a number of normalization bits per IQ sample, N_{cw} is a number of control words per IQ sample, and OH_{FEC} is a FEC overhead value. For instance, after calculations of generic simulation values are applied to the FEC complexity formula, a nearly 50% reduction in FEC complexity is calculated.

Therefore, the quantization-based MCS fronthaul transmission offers better transmission performance due to the protection of the MSBs during the transmitting process. Furthermore, as compared to conventional scheme, quantization-based MCS fronthaul provides higher bandwidth efficiency due to the utilization of the PCM and offers a lower system complexity requirement by removing the need to protect all the bits.

FIG. 7B is a schematic diagram of a quantization-based MCS fronthaul communication system 700A that comprises a sub-transmitter 730 and a sub-receiver 750 configured for dynamic equalizer training according to an embodiment of the disclosure. The system 700B comprises the sub-transmitter 730, a transmission channel 707, and the sub-receiver 750. The system 700B discloses an in-depth configuration of the sub-transmitter 730 and the sub-receiver 750 of the embodiment disclosed in the system 700A. In an embodiment, the sub-transmitter 730 comprises a FD-DMT transmitter and the sub-receiver 750 comprises a FD-DMT receiver. In the sub-transmitter 730, the sub-transmitter 730 is configured to dynamically allocate subcarriers for QAM and PCM. This approach allows CWs and QAM MSBs (i.e., QAM signals) to be periodically sent through all subcarriers. In an embodiment, the approach is utilizing an equalization training method such as decision-directed least-mean-square (LMS) to apply equalizer updates. In the sub-receiver 750, equalizers II 767, equalizer I 770 and the updater 773 may be utilized to apply the decision-directed LMS. For example, the decision-directed LMS can be applied in equalizer I 770 of the QAM, and then equalizer coefficients obtained in equalizer I 770 are updated using the updater 773 and copied to equalizer II 767 for the PCM.

The sub-transmitter 730 comprises a subcarrier mapper 753, an inverse fast Fourier transformer (IFFT) 755, and a cyclic prefix adder 757. The subcarrier mapper 753 receives a QAM or PCM signal and allocates the QAM or PCM signal among all subcarriers for the QAM or PCM signal to form allocated QAM or PCM signal. Next, the subcarrier mapper 753 sends the allocated QAM or PCM signal to the IFFT 755. The IFFT 755 applies an IFFT algorithm to create a time-domain waveform of the allocated QAM or PCM signal. The IFFT 755 then sends the time-domain waveform to the cyclic prefix adder 757. The cyclic prefix adder 757 performs a cyclic prefixing on the time-domain waveform to create a prefixed time-domain signal. The prefixed time-domain signal is transmitted to the sub-receiver 750 through a transmission channel 707 for further processing.

The sub-receiver 750 comprises a cyclic prefix remover 760, a fast Fourier transformer (FFT) 763, a subcarrier de-mapper 765, equalizer II 767, equalizer I 770, and an updater 773. The cyclic prefix remover 760 receives the prefixed time-domain waveform and removes the cyclic prefix. Next, the cyclic prefix remover 760 sends the time-domain waveform to the FFT 763. The FFT 763 applies the FFT to retrieve the QAM or PCM signal in an allocated form prior to the transformation and sends the allocated QAM or PCM signal to subcarrier de-mapper 765. The subcarrier de-mapper 765 then performs a de-mapping on the allocated QAM or PCM signal to retrieve the QAM or PCM signal in its original form. Next, depending on whether the signal is a QAM signal or a PCM signal, the signal is sent to equalizer I 770 when the signal is a QAM signal or the signal is sent to equalizer II 767 when the signal is a PCM signal. The equalizer I 770 applies an equalization method such as decision-directed LMS to the QAM signal and sends an equalizer coefficient to the updater 773 to update the coefficient value. Thereafter, the equalizer coefficient is copied from the equalizer I 770 and sent to the equalizer II 767 for the PCM signal.

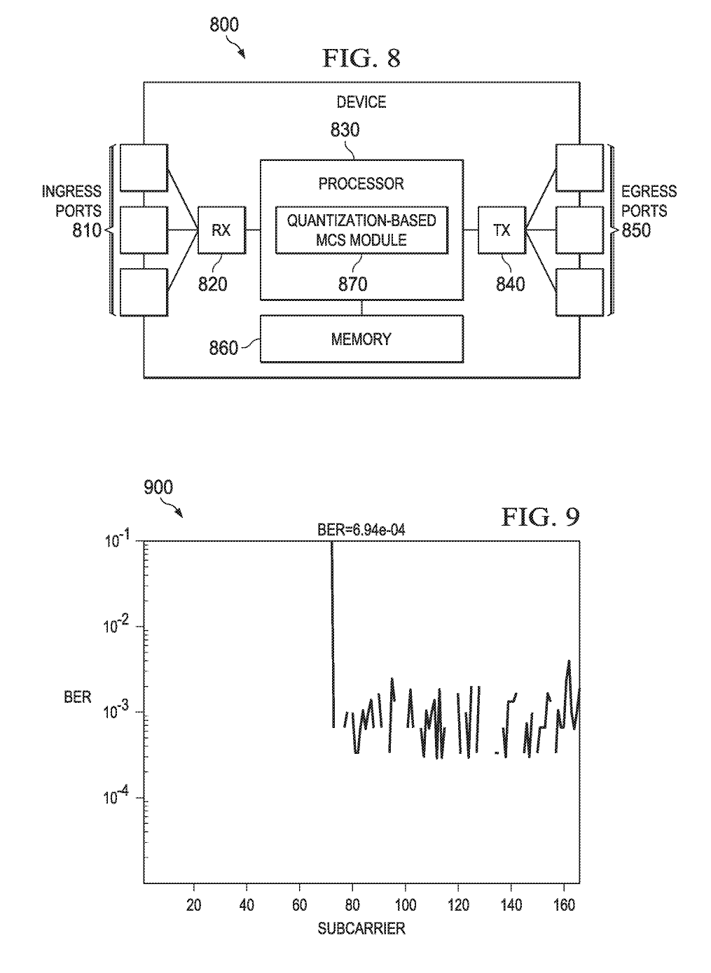

FIG. 8 is a schematic diagram of a quantization-based MCS fronthaul communication device 800 according to an embodiment of the disclosure. The device 800 may be similar to the transmitter 703 or the receiver 705. The device 800 comprises ingress ports 810 and receiver units (Rx) 820 for receiving data; a processor, logic unit, or central processing unit (CPU) 830 to process the data; transmitter units (Tx) 840 and egress ports 850 for transmitting the data; and a memory 860 for storing the data. The device 800 may also comprise optical-to-electrical (OE) components and electrical-to-optical (EO) components coupled to the ingress ports 810, the receiver units 820, the transmitter units 840, and the egress ports 850 for ingress or egress of optical or electrical signals.

The processor 830 is implemented by any suitable combination of hardware, middleware, firmware, or software. The processor 830 may be implemented as one or more CPU chips, cores (e.g., as a multi-core processor), field-programmable gate arrays (FPGAs), application specific integrated circuits (ASICs), or digital signal processors. The processor 830 is in communication with the ingress ports 810, receiver units 820, transmitter units 840, egress ports 850, and memory 860. The processor 830 comprises a quantization-based MCS module 870. The quantization-based MCS module 870 implements the disclosed embodiments. For example, the Rx 820 is similar to the CPRI 710; the quantization-based MCS module 870 is similar to a suitable combination of the compressor 713, the quantization separator 715, the gain amplifier 717, the multiplexer 720, the FEC encoder 723, the PCM component 725, and the QAM component 727; and the Tx 840 is similar to the sub-transmitter 730 located in the transmitter 703 as shown in FIG. 7. For another example, the Rx 820 is similar to the sub-receiver 750; the quantization-based MCS module 870 is similar to a suitable combination of the FEC decoder 745, the de-multiplexer 743, the suppressor 740, the PCM component 737, the combiner 735, and the decompressor 733; the Tx 840 is similar to the CPRI 710 located in receiver 705 as shown in FIG. 7. For another instance, the inclusion of the quantization-based MCS module 870 provides a substantial improvement to spectrum efficiency and system complexity. The quantization-based MCS module 870 further improves the functionality of the device 800 and effects a transformation of the device 800 to a different state. Alternatively, the memory 860 may store the quantization-based MCS module as instructions, and the processor 830 executes those instructions.

The memory 860 comprises one or more disks, tape drives, or solid-state drives and may be used as an over-flow data storage device, to store programs when such programs are selected for execution, or to store instructions and data that are read during program execution. The memory 860 may be volatile and/or non-volatile and may be read-only memory (ROM), random-access memory (RAM), ternary content-addressable memory (TCAM), or static random-access memory (SRAM).

FIG. 9 is a graph 900 illustrating BER versus subcarrier with quantization-based MCS according to an embodiment of the disclosure. The x-axis represents subcarrier in constant units, and the y-axis represents BER in constant units. Subcarriers above 70 are used for QAM signals in this example, while subcarriers below 70 are assigned to send PCM signals. Thus the BER measurement is not plotted in the region below 70. As shown in the figure, the BER is about 10⁻³. The graph further displays a BER=6.96e⁻⁰⁴, which meets the FEC requirement.

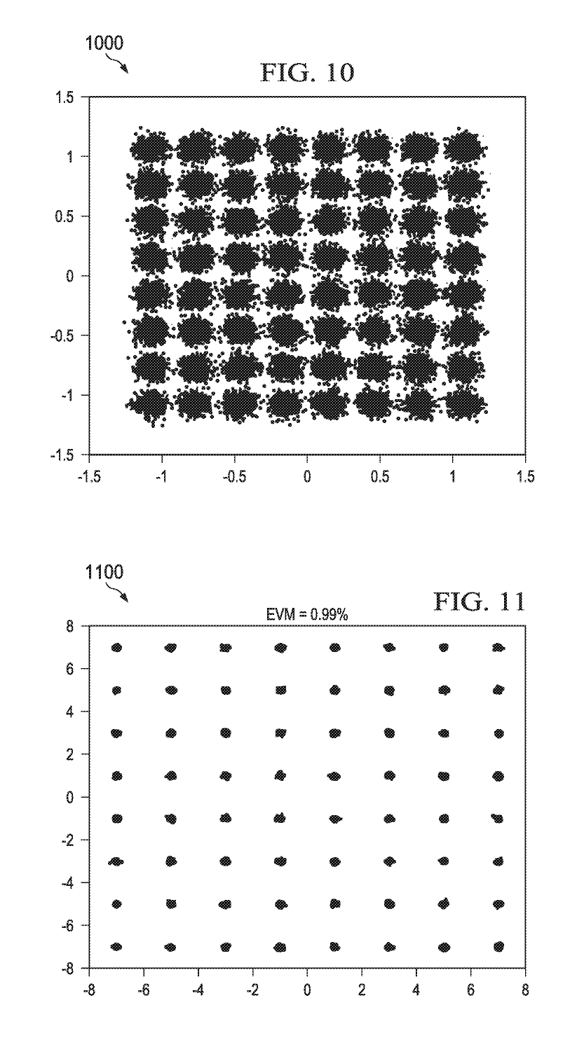

FIG. 10 is a graph 1000 illustrating received QAM constellation points with quantization-based MCS according to an embodiment of the disclosure. The x-axis represents in-phase (I) in constant units, and the y-axis represents quadrature (Q) in constant units. The graph 1000 is a constellation diagram that comprises a plurality of sampling dots. The sampling dots represent the IQ data taken from the input of FEC decoder 745 in the receiver 705. In an ideal fronthaul transmission, the IQ data sampling will be much more concentrated to a single dot on the graph instead of a plurality of various values. FIG. 10 displays less concentration of sampling dots than FIG. 6.

FIG. 11 is a graph 1100 illustrating received LTE QAM constellation points with quantization-based MCS according to an embodiment of the disclosure. The corresponding EVM is 0.99. The x-axis represents in-phase (I) in constant units, and the y-axis represents quadrature (Q) in constant units. The graph 1100 is a constellation diagram that comprises a plurality of sampling dots. The sampling dots represent the IQ data taken from the output of decompressor 733 in the receiver 705. The error vector magnitude (EVM) is 0.99% which is below a common targeted value of 1%, thus proving better performance.

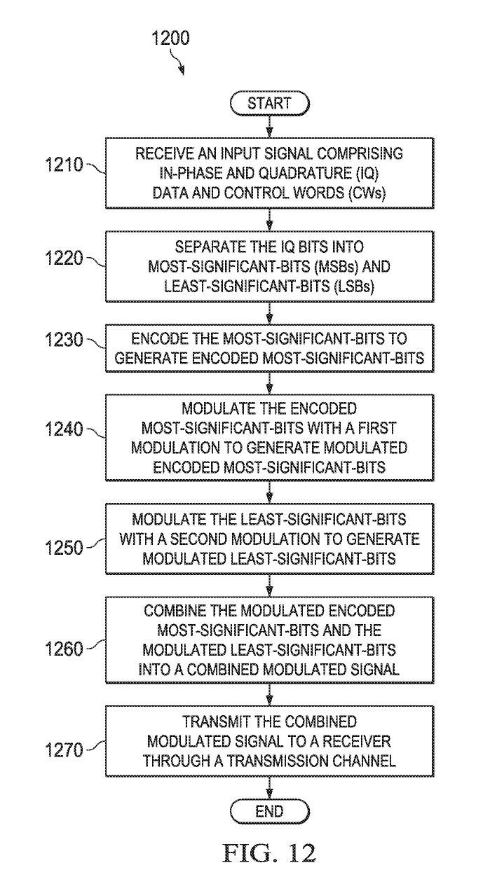

FIG. 12 is a flowchart 1200 of a method performing quantization-based MCS processing by a transmitter and a receiver configured to send and receive packets over a transmission channel according to an embodiment of the disclosure. The method in flowchart 1200 is implemented by transmitter 703 when transmissions with quantization-based MCS fronthaul communication system 700 processing are going to be made. At step 1210, quantized in-phase and quadrature (IQ) bits of an input signal are received. For instance, the CPRI 710 receives the IQ bits from the RRU 110 or BBU 120, and transmits the IQ bits towards the compressor 713 and the multiplexer 720. At step 1220, the IQ bits are separated into most-significant-bits (MSBs) and least-significant-bits (LSBs). For another instance, the quantization separator 715 separates the IQ bits into a string of MSBs and a string of LSBs. At step 1230, the MSBs are encoded with an encoding to generate encoded MSBs. For example, the FEC encoder 723 protects the MSBs by performing a forward error correction (FEC) encoding scheme on the MSBs to generate encoded MSBs. At step 1240, the encoded MSBs are modulated with a first modulation to generate modulated encoded MSBs. For instance, the QAM component 727 modulates the MSBs with quadrature amplitude modulation to generate modulated encoded MSBs. At step 1250, the LSBs are modulated with a second modulation to generate modulated LSBs. For instance, the PCM component 725 modulates the LSBs with pulse-code modulation to generate modulated LSBs. At step 1260, the modulated encoded MSBs and the modulated LSBs are combined into a combined modulated signal. For instance, the sub-transmitter 730 combines the MSBs and the LSBs into a combined modulated signal for transmission. At step 1270, the combined modulated signal is transmitted to a remote receiver through a transmission channel. For instance, the sub-transmitter 730 transmits the combined modulated signal to a remote receiver such as receiver 705 through a transmission channel 707 or a fronthaul link 130.

Disclosed herein is a method implemented in a communication device. The method includes means for receiving quantized in-phase and quadrature (IQ) bits of an input signal, means for separating the IQ bits into most-significant-bits (MSBs) and least-significant-bits (LSBs), means for encoding the MSBs to generate encoded MSBs, means for modulating the encoded MSBs with a first modulation to generate modulated encoded MSBs, means for modulating the LSBs with a second modulation to generate modulated LSBs, means for combining the modulated encoded MSBs and the modulated LSBs into a combined modulated signal, and means for transmitting the combined modulated signal to a receiver through a transmission channel.

Disclosed herein is an apparatus having means for receiving a combined modulated signal including most-significant-bits (MSBs) and the least-significant-bits (LSBs) of an input signal, means for separating the MSBs from the combined modulated signal via a first demodulation and decoding, means for separating the LSBs from the combined modulated signal via a second demodulation, wherein the second demodulation is different from the first demodulation, means for recombining the MSBs and the LSBs to generate a reconstructed representation of the input signal including in-phase and quadrature (IQ) bits, and means for providing the IQ bits to a remote radio unit (RRU) for transmission to a mobile device via an antenna.

Disclosed herein is an apparatus including means for receiving an input signal including IQ bits and CWs bits, means for dividing the IQ bits into most-significant-bits (MSBs) and least-significant-bits (LSBs), means for encoding the MSBs to form encoded MSBs, means for modulating the encoded MSBs with a first modulation to form a modulated encoded MSBs, means for modulating the LSBs with a second modulation to form a modulated LSBs, means for combining the modulated encoded MSBs and the modulated LSBs into a combined modulated signal, and means for synchronously transmitting the combined modulated signal to a receiver over a transmission channel.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, units, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method implemented in a communication device, comprising:
receiving, by the communication device, quantized in-phase and quadrature (IQ) bits of an input signal;
separating, by the communication device, the IQ bits into most-significant-bits (MSBs) and least-significant-bits (LSBs);
encoding, by the communication device, the MSBs to generate encoded MSBs;
modulating, by the communication device, the encoded MSBs with a first modulation to generate modulated encoded MSBs;
modulating, by the communication device, the LSBs with a second modulation to generate modulated LSBs;
combining, by the communication device, the modulated encoded MSBs and the modulated LSBs into a combined modulated signal; and
transmitting, by the communication device, the combined modulated signal via a transmission channel.

2. The method of claim 1, wherein the MSBs are encoded using forward error correction (FEC).

3. The method of claim 1, wherein the MSBs are encoded using a Trellis coded modulation.

4. The method of claim 1, wherein the first modulation is a quadrature amplitude modulation (QAM).

5. The method of claim 1, wherein the second modulation is a pulse-code modulation (PCM).

6. The method of claim 1, wherein the combined modulated signal is transmitted using a frequency-domain discrete multi-tone (FD-DMT) transmitter.

7. The method of claim 1, wherein the combined modulated signal is transmitted using a time-domain single-carrier (TD-SC) transmitter.

8. An apparatus comprising:
a receiver configured to receive a combined modulated signal comprising most-significant-bits (MSBs) and least-significant-bits (LSBs) of an input signal;
a processor coupled to the receiver and configured to:
separate the MSBs from the combined modulated signal via a first demodulation and decoding;
separate the LSBs from the combined modulated signal via a second demodulation, wherein the second demodulation is different from the first demodulation;
recombine the MSBs and the LSBs to generate a reconstructed representation of the input signal comprising in-phase and quadrature (IQ) bits; and
provide the IQ bits to a remote radio unit (RRU) for transmission.

9. The apparatus of claim 8, wherein the first demodulation is a quadrature amplitude modulation (QAM).

10. The apparatus of claim 8, wherein the MSBs are decoded by a forward error correction (FEC) decoder.

11. The apparatus of claim 8, wherein the second demodulation is a pulse-code modulation (PCM).

12. The apparatus of claim 8, wherein the apparatus comprises a transceiver including a frequency-domain discrete multi-tone (FD-DMT) receiver.

13. The apparatus of claim 8, wherein the apparatus comprises a transceiver including a time-domain single-carrier (TD-SC) receiver.

14. The apparatus of claim 8, wherein a channel equalizer is coupled to the receiver and configured to equalize the combined modulated signal comprising the MSBs and the LSBs.

15. The apparatus of claim 14, wherein the channel equalizer is updated using the MSBs.

16. The apparatus of claim 14, wherein the channel equalizer is trained using training symbols.

17. An apparatus comprising:
a receiver configured to receive an input signal comprising in-phase and quadrature (IQ) bits and control words (CWs) bits;
a processor coupled to the receiver and configured to:
divide the IQ bits into most-significant-bits (MSBs) and least-significant-bits (LSBs);
encode the MSBs to form encoded MSBs;
modulate the encoded MSBs with a first modulation to form a modulated encoded MSBs;
modulate the LSBs with a second modulation to form a modulated LSBs; and
combine the modulated encoded MSBs and the modulated LSBs into a combined modulated signal; and
a transmitter coupled to the processor and configured to synchronously transmit the combined modulated signal over a transmission channel.

18. The apparatus of claim 17, wherein the MSBs and LSBs are divided according to an error-vector-magnitude (EVM) requirement.

19. The apparatus of claim 17, wherein the MSBs are modulated with the first modulation comprising a quadrature amplitude modulation (QAM) following the encoding.

20. The apparatus of claim 17, wherein the second modulation is a pulse-code modulation (PCM).

21. The apparatus of claim 17, wherein the processor is further configured to adjust a mean power of the modulated LSBs with respect to a mean power of the modulated encoded MSBs.

22. The apparatus of claim 17, wherein a difference between a mean power of the modulated LSBs and a mean power of the modulated encoded MSBs is determined according to an error-vector-magnitude (EVM) requirement.

23. The apparatus of claim 17, wherein the processor is further configured to generate normalization bits before the IQ bits are divided.

24. The apparatus of claim 22, wherein the normalization bits are transmitted together with the MSBs of the combined modulated signal.

25. The apparatus of claim 17, wherein the control words (CWs) bits are transmitted together with the MSBs of the combined modulated signal.
